(19) United States
(12) Patent Application Publication
(10) Pub. No.: US 2023/0201641 A1
(43) Pub. Date: Jun. 29, 2023

(54) FIRE SUPPRESSANT ASSEMBLY

(71) Applicants: Kevin Kinses, Anaheim, CA (US); Michael Warino, Anaheim, CA (US)

(72) Inventors: Kevin Kinses, Anaheim, CA (US); Michael Warino, Anaheim, CA (US)

(21) Appl. No.: 17/562,156

(22) Filed: Dec. 27, 2021

(51) Int. Cl. A62C 3/02; A62C 37/44; A62C 35/68

(52) U.S. Cl. CPC A62C 3/0214; A62C 3/0292; A62C 37/44; A62C 35/68

(57) ABSTRACT

A fire suppressant assembly includes a fluid reservoir that contains an extinguishing fluid and the fluid reservoir is positioned within a predetermined distance of a building. A pump is positioned below ground and the pump is in fluid communication with the fluid reservoir to urge the extinguishing fluid outwardly from the fluid reservoir. A plurality of stand pipes is each of the stand pipes is distributed around the building and each of the stand pipes receives the extinguishing fluid from the pump. A plurality of nozzles is each of the nozzles is coupled to a respective one of the stand pipes to spray the extinguishing fluid outwardly from the nozzles onto the roof of the building to inhibit the roof of the building from combusting.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to suppressant devices and more particularly pertains to a new suppressant device for inhibiting a building from combusting. The device includes a fluid reservoir which contains an extinguishing fluid and a pump, buried below ground, the pumps the extinguishing fluid. The device includes a plurality of stand pipes, each being distributed around a building, which receive the extinguishing fluid from the pump. Additionally, the device includes a plurality of nozzles, each being fluidly coupled to a respective stand pipe, for spraying the extinguishing fluid over the building in a cascading shower to soak the building and inhibit the building from combusting.

### (2) Description of Related Art Including Information Disclosed Under 37 CFR 1.97 and 1.98

The prior art relates to suppressant devices including a fire suppression device that includes conduits that are integrated into a roof of a building and a swimming pool that is in fluid communication with the conduits for extinguishing a fire in the building. The prior art discloses a fire suppression device that includes a plurality of spray nozzles, each distributed around a building, for spraying water on the building for fire suppression. The prior art discloses a variety of fire suppression devices that each at least includes a plurality of sprinkler heads, each being disposed on an exterior of a building, for suppressing a fire on an exterior of the building. The prior art discloses a fire suppression device that includes a below ground pump, a plurality of spray nozzles distributed around a building and a conduit integrated into an apex of the building for fire suppression.

### BRIEF SUMMARY OF THE INVENTION

An embodiment of the disclosure meets the needs presented above by generally comprising a fluid reservoir that contains an extinguishing fluid and the fluid reservoir is positioned within a predetermined distance of a building. A pump is positioned below ground and the pump is in fluid communication with the fluid reservoir to urge the extinguishing fluid outwardly from the fluid reservoir. A plurality of stand pipes is each of the stand pipes is distributed around the building and each of the stand pipes receives the extinguishing fluid from the pump. A plurality of nozzles is each of the nozzles is coupled to a respective one of the stand pipes to spray the extinguishing fluid outwardly from the nozzles onto the roof of the building to inhibit the roof of the building from combusting.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a phantom perspective view of a fire suppressant assembly according to an embodiment of the disclosure.

FIG. 2 is a top view of an embodiment of the disclosure.

FIG. 3 is a top perspective view of an embodiment of the disclosure.

FIG. 4 is a detail view taken from circle 4 of FIG. 3 of an embodiment of the disclosure.

FIG. 5 is a schematic view of an embodiment of the disclosure.

### DETAILED DESCRIPTION OF THE INVENTION

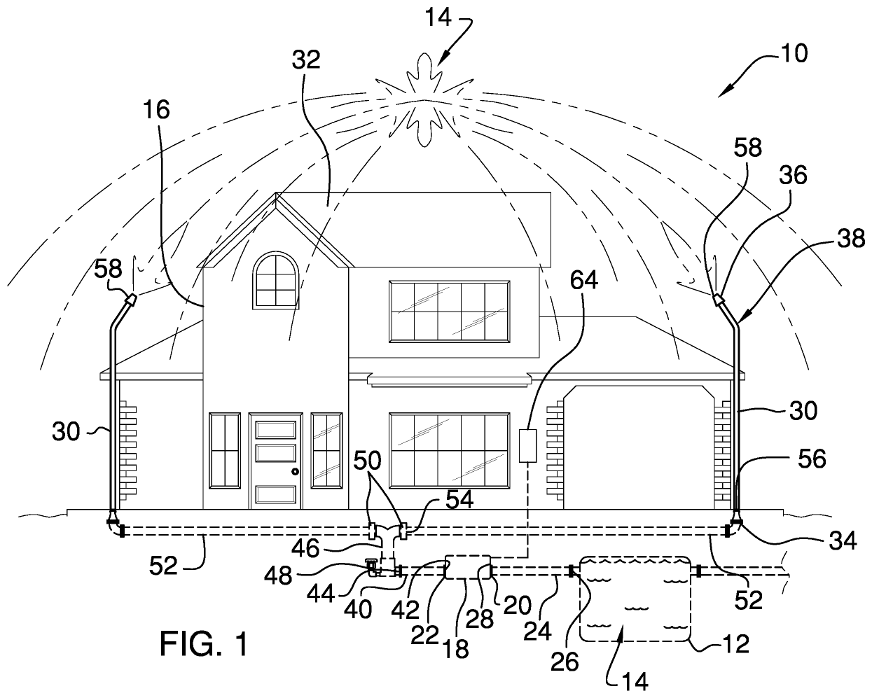

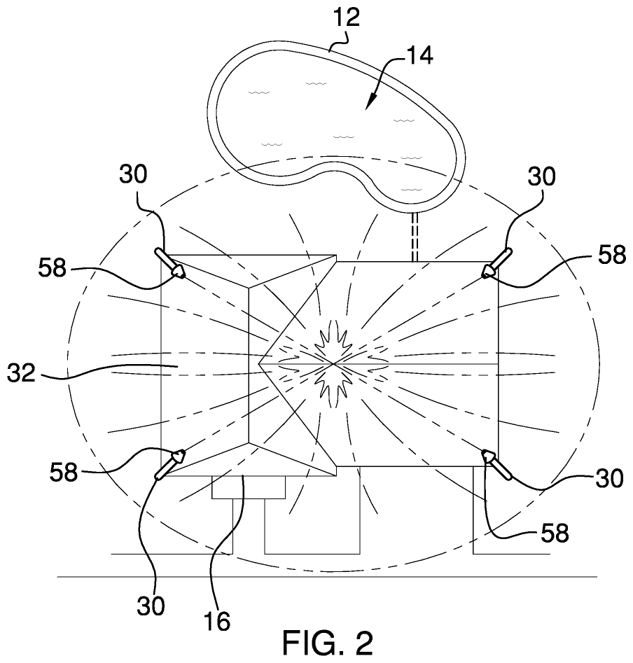

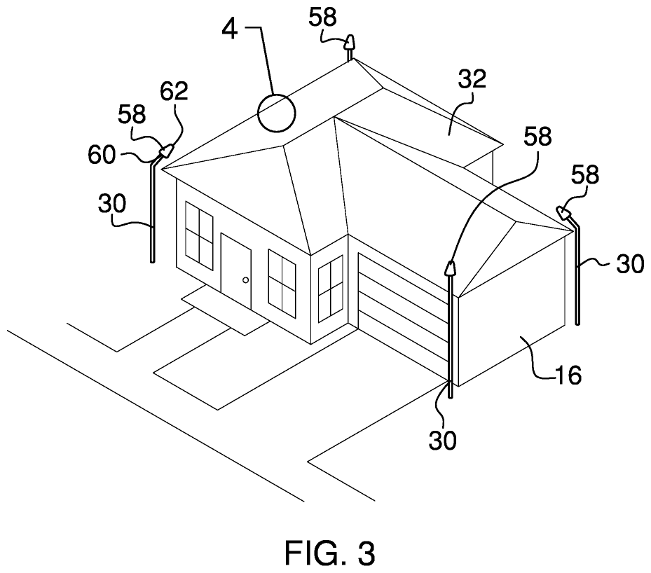

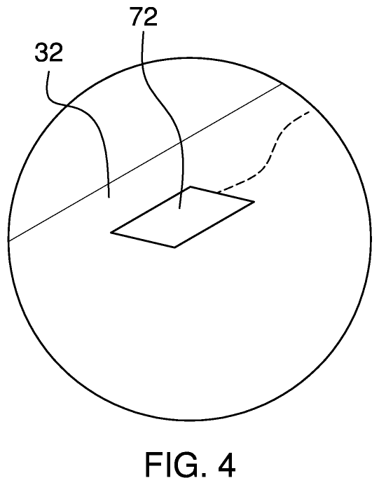

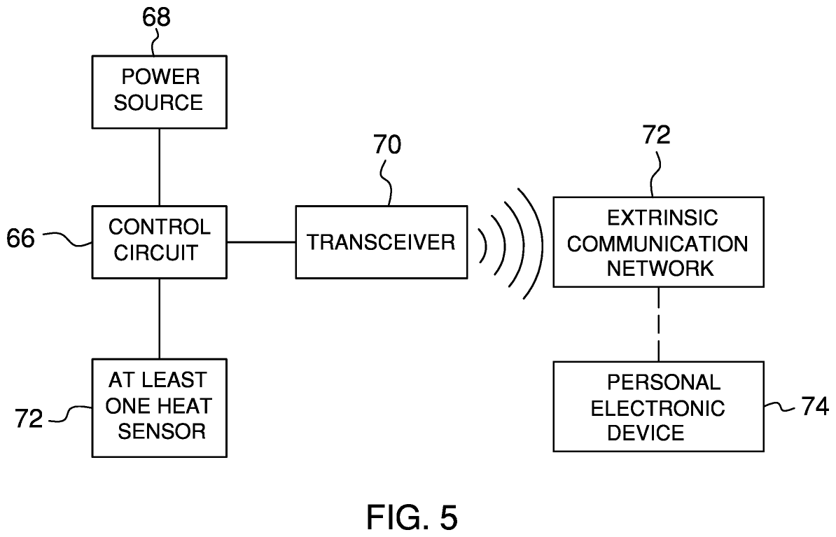

With reference now to the drawings, and in particular to FIGS. 1 through 5 thereof, a new suppressant device embodying the principles and concepts of an embodiment of the disclosure and generally designated by the reference numeral 10 will be described.

As best illustrated in FIGS. 1 through 5, the fire suppressant assembly 10 generally comprises a fluid reservoir 12 containing an extinguishing fluid 14. The fluid reservoir 12 is positioned within a predetermined distance of a building 16. The extinguishing fluid 14 may comprise water, fire retarding foam or any other type of fluid that is commonly employed for extinguishing a fire. Additionally, the fluid reservoir 12 may comprise a swimming pool, a fluid tank or any other type of fluid containment that has a fluid capacity of at least 10,000.0 liters. The fluid reservoir 12 might additionally comprise a municipal water supply system. The building 16 may comprise a house, a public building or any other structure that would commonly be occupied by one or more people.

A pump 18 is provided and the pump 18 is positioned below ground. The pump 18 is in fluid communication with the fluid reservoir 12 thereby facilitating the pump 18 to urge the extinguishing fluid 14 outwardly from the fluid reservoir 12. Furthermore, the pump 18 has an intake 20 and an exhaust 22. The pump 18 may comprise an electric fluid pump or the like and the pump 18 may have an operational output of at least 3500.0 liters per minute.

A feed pipe 24 is provided and the feed pipe 24 is positioned below ground. The feed pipe 24 has a first end 26 and a second end 28, and the first end 26 of the feed pipe 24 is fluidly coupled to the fluid reservoir 12. Additionally, the second end 28 of the feed pipe 24 is fluidly coupled to the intake 20 of the pump 18. A plurality of stand pipes 30 is provided and each of the stand pipes 30 is distributed around the building 16. Each of the stand pipes 30 is vertically oriented such that each of the stand pipes 30 extends to a height that is approximately equal to a height of a roof 32 of the building 16. Additionally, each of the stand pipes 30 is in fluid communication with the pump 18 such that each of the stand pipes 30 receives the extinguishing fluid 14 from the pump 18.

Each of the stand pipes 30 has a bottom end 34 and an upper end 36, and each of the stand pipes 30 penetrates the ground having the bottom end 34 being positioned below ground. The stand pipes 30 are spaced apart from each other and are distributed around the building 16. Each of the stand pipes 30 is strategically located with respect to structural characteristics of the roof 32 of the building 16. Each of the stand pipes 30 has a bend 38 is integrated into the stand pipes 30 and the bend 38 in each of the stand pipes 30 is positioned adjacent to the upper end 36 of the stand pipes 30. In this way the upper end 36 of each of the stand pipes 30 is directed toward the roof 32 of the building 16.

A first supply pipe 40 is provided that has a first end 42 and a second end 44. The first end 42 of the first supply pipe 40 is fluidly coupled to the exhaust 22 of the pump 18 such that the first supply pipe 40 receives the extinguishing fluid 14 from the pump 18. A manifold 46 is included that has an inlet 48 and a plurality of outlets 50, and the manifold 46 is positioned below ground. The inlet 48 is fluidly coupled to the second end of the first supply pipe 40 such that the manifold 46 receives the extinguishing fluid 14 from the first supply pipe 40, and each of the outlets 50 is in fluid communication with the inlet 48.

A plurality of second supply pipes 52 is provided, each of the second supply pipes 52 is positioned below ground, and each of the second supply pipes 52 has a first end 54 and a second end 56. The first end of each of the second supply pipes 52 is fluidly coupled to a respective one of the outlets 50 of the manifold 46 such that each of the second supply pipes 52 receives the extinguishing fluid 14 from the manifold 46. The second end 56 of each of the second supply pipes 52 is fluidly coupled to the bottom end 34 of a respective one of the stand pipes 30 such that each of the stand pipes 30 receives the extinguishing fluid 14 from a respective second supply pipe 52.

A plurality of nozzles 58 is provided and each of the nozzles 58 is coupled to a respective one of the stand pipes 30 such that each of nozzles 58 sprays the extinguishing fluid 14 outwardly from the nozzles 58 onto the roof 32 of the building 16. In this way each of the nozzles 58 inhibit the roof 32 of the building 16 from combusting. Each of the nozzles 58 has a coupled end 60 and a free end 62, and the coupled end 60 of each of the nozzles 58 is fluidly coupled to the upper end 36 of each of the stand pipes 30. The free end 62 of each of the nozzles 58 is open thereby facilitating the free end 62 of each of the nozzles 58 to spray the extinguishing fluid 14 outwardly from the free end 62.

Each of the stand pipes 30 is oriented such that the upper end 36 of each of the stand pipes 30 is directed toward a common point located above the roof 32 of the building 16. In this way each of the nozzles 58 sprays a stream of the extinguishing fluid 14 in an arc which intersects at the common point above the roof 32. Subsequently, the stream of extinguishing fluid 14 sprayed from each of the nozzles 58 forms a cascading shower of the extinguishing fluid 14 onto the roof 32. In this way the roof 32 of the building 16 and the area surrounding the building 16 is thoroughly soaked with the extinguishing fluid 14. Thus, the building 16 and the surrounding area are inhibited from catching fire, and an existing fire on the building 16 or the surrounding area is extinguished.

A control unit 64 is positioned proximate the building 16 and the control unit 64 is in communication with the pump 18. The control unit 64 receives an actuate input, and the pump 18 is turned on when the control unit 64 receives the actuate input. The control unit 64 comprises a control circuit 66 that is electrically coupled to the pump 18. The control circuit 66 receives the actuate input and the control circuit 66 turns on the pump 18 when the control circuit 66 receives the actuate input. Additionally, the control circuit 66 is electrically coupled to a power source 68 comprising an electrical system of the building 16.

The control unit 64 includes a transceiver 70 that is electrically coupled to the control circuit 66. The transceiver 70 is in wireless communication with an extrinsic communication network 72 thereby facilitating the transceiver 70 to be in remote communication with a personal electronic device 74 of an occupant of the building 16. The extrinsic communication network 72 may be the Internet, a cellular phone network or any other wireless communication system. Additionally, the personal electronic device 74 may comprise a smart phone or other similar electronic device that has wireless communication capabilities. Furthermore, the personal electronic device 74 may store control software, such as a smart phone app or the like, to facilitate the personal electronic device 74 to remotely control the pump 18.

The control circuit 66 receives the actuate input when the transceiver 70 receives an actuate command from the extrinsic communication network 72. In this way the transceiver 70 facilitates the personal electronic device 74 to actuate the pump 18. The control unit 64 includes at least one heat sensor 72 that is positioned on the roof 32 of the building 16. In this way the at least one heat sensor 72 can sense the temperature of the roof 32. The at least one heat sensor 72 is electrically coupled to the control circuit 66 and the control circuit 66 receives the actuate input when the at least one heat sensor 72 senses a temperature exceeding a pre-determined trigger temperature. The at least one heat sensor 72 may comprise an electronic heat sensor or the like and the pre-determined trigger temperature may be a temperature of approximately 200.0 degrees Fahrenheit.

In use, the pump 18 is turned on when the at least one heat sensor 72 senses a temperature that exceeds the pre-determined trigger temperature. In this way the building 16 and the area surrounding the building 16 are soaked with the extinguishing fluid 14. Thus, the building 16 and the surrounding area are inhibited from combusting as a result of an approaching wild fire, for example. Additionally, a fire that is started on the roof 32 of the building 16 can be extinguished before the building 16 is destroyed by the fire. The personal electronic device 74 can be manipulated to actuate the pump 18 and subsequently soak the building 16 and the surrounding area with the extinguishing fluid 14.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fire suppressant assembly for extinguishing a fire on an exterior of a building, said assembly comprising:
a fluid reservoir containing an extinguishing fluid, said fluid reservoir being positioned within a predetermined distance of a building;
a pump being positioned below ground, said pump being in fluid communication with said fluid reservoir thereby facilitating said pump to urge said extinguishing fluid outwardly from said fluid reservoir;
a plurality of stand pipes, each of said stand pipes being distributed around the building, each of said stand pipes being vertically oriented such that each of said stand pipes extends to a height being approximately equal to a height of a roof of the building, each of said stand pipes being in fluid communication with said pump such that each of said stand pipes receives said extinguishing fluid from said pump;
a plurality of nozzles, each of said nozzles being coupled to a respective one of said stand pipes such that each of nozzles sprays said extinguishing fluid outwardly from said nozzles onto the roof of the building wherein each of said nozzles is configured to inhibit the roof of the building from combusting; and
a control unit being positioned proximate the building, said control unit being in communication with said pump, said control unit receiving an actuate input, said pump being turned on when said control unit receives said actuate input.

2. The assembly according to claim 1, wherein:
said pump has an intake and an exhaust;
said assembly includes a feed pipe being positioned below ground, said feed pipe having a first end and a second end, said first end of said feed pipe being fluidly coupled to said fluid reservoir, said second end of said feed pipe being fluidly coupled to said intake of said pump;
a first supply pipe having a first end and a second end, said first end of said first supply pipe being fluidly coupled to said exhaust of said pump such that said first supply pipe receives said extinguishing fluid from said pump; and
a manifold having an inlet and a plurality of outlets, said manifold being positioned below ground, said inlet being fluidly coupled to said second end of said first supply pipe such that said manifold receives said extinguishing fluid from said first supply pipe, each of said outlets being in fluid communication with said inlet.

3. The assembly according to claim 2, wherein:
each of said stand pipes having a bottom end and an upper end, each of said stand pipes penetrating the ground having said bottom end being positioned below ground; and
said assembly includes a plurality of second supply pipes, each of said second supply pipes being positioned below ground, each of said second supply pipes having a first end and a second end, said first end of each of said second supply pipes being fluidly coupled to a respective one of said outlets of said manifold such that each of said second supply pipes receives said extinguishing fluid from said manifold, said second end of each of said second supply pipes being fluidly coupled to said bottom end of a respective one of said stand pipes such that each of said stand pipes receives said extinguishing fluid from a respective second supply pipe.

4. The assembly according to claim 1, wherein:
each of said stand pipes has a bottom end and an upper end, each of said stand pipes penetrating the ground having said bottom end being positioned below ground; and
each of said nozzles has a coupled end and a free end, said coupled end of each of said nozzles being fluidly coupled to said upper end of each of said stand pipes, said free end of each of said nozzles being open thereby facilitating said free end of each of said nozzles to spray the extinguishing fluid outwardly from said free end.

5. The assembly according to claim 4, wherein:
said stand pipes are spaced apart from each other and are distributed around the building, each of said stand pipes being strategically located with respect to structural characteristics of the roof of the building, each of said stand pipes having a bend being integrated into said stand pipes, said bend in each of said stand pipes being positioned adjacent to said upper end of said stand pipes such that said upper end of each of said stand pipes is directed toward the roof of the building; and
each of said stand pipes is oriented such that said upper end of each of said stand pipes is directed toward a common point located above the roof of the building thereby facilitating each of said nozzles to spray a stream of said extinguishing fluid in an arc which intersects at said common point above the roof thereby facilitating said stream of extinguishing fluid sprayed from each of said nozzles to form a cascading shower of said extinguishing fluid onto the roof.

6. The assembly according to claim 1, wherein said control unit comprising:
a control circuit being electrically coupled to said pump, said control circuit receiving said actuate input, said control circuit turning said pump on when said control circuit receives said actuate input, said control circuit being electrically coupled to a power source comprising an electrical system of the building;
a transceiver being electrically coupled to said control circuit, said transceiver being in wireless communication with an extrinsic communication network wherein said transceiver is configured to be in remote communication with a personal electronic device of an occupant of the building, said control circuit receiving said actuate input when said transceiver receives an actuate command from the extrinsic communication network wherein said transceiver is configured to facilitate the personal electronic device to actuate said pump; and
at least one heat sensor being positioned on the roof of the building wherein said heat sensor is configured to sense the temperature of the roof, said at least one heat sensor being electrically coupled to said control circuit, said control circuit receiving said actuate input when said at least one heat sensor senses a temperature exceeding a pre-determined trigger temperature.

7. A fire suppressant assembly for extinguishing a fire on an exterior of a building, said assembly comprising:
a fluid reservoir containing an extinguishing fluid, said fluid reservoir being positioned within a predetermined distance of a building;
a pump being positioned below ground, said pump being in fluid communication with said fluid reservoir thereby facilitating said pump to urge said extinguishing fluid outwardly from said fluid reservoir, said pump having an intake and an exhaust;
a feed pipe being positioned below ground, said feed pipe having a first end and a second end, said first end of said feed pipe being fluidly coupled to said fluid reservoir, said second end of said feed pipe being fluidly coupled to said intake of said pump;
a plurality of stand pipes, each of said stand pipes being distributed around the building, each of said stand pipes being vertically oriented such that each of said stand pipes extends to a height being approximately equal to a height of a roof of the building, each of said stand pipes being in fluid communication with said pump such that each of said stand pipes receives said extinguishing fluid from said pump, each of said stand pipes having a bottom end and an upper end, each of said stand pipes penetrating the ground having said bottom end being positioned below ground, said stand pipes being spaced apart from each other and being distributed around the building, each of said stand pipes being strategically located with respect to structural characteristics of the roof of the building, each of said stand pipes having a bend being integrated into said stand pipes, said bend in each of said stand pipes being positioned adjacent to said upper end of said stand pipes such that said upper end of each of said stand pipes is directed toward the roof of the building;
a first supply pipe having a first end and a second end, said first end of said first supply pipe being fluidly coupled to said exhaust of said pump such that said first supply pipe receives said extinguishing fluid from said pump;
a manifold having an inlet and a plurality of outlets, said manifold being positioned below ground, said inlet being fluidly coupled to said second end of said first supply pipe such that said manifold receives said extinguishing fluid from said first supply pipe, each of said outlets being in fluid communication with said inlet;
a plurality of second supply pipes, each of said second supply pipes being positioned below ground, each of said second supply pipes having a first end and a second end, said first end of each of said second supply pipes being fluidly coupled to a respective one of said outlets of said manifold such that each of said second supply pipes receives said extinguishing fluid from said manifold, said second end of each of said second supply pipes being fluidly coupled to said bottom end of a respective one of said stand pipes such that each of said stand pipes receives said extinguishing fluid from a respective second supply pipe;
a plurality of nozzles, each of said nozzles being coupled to a respective one of said stand pipes such that each of nozzles sprays said extinguishing fluid outwardly from said nozzles onto the roof of the building wherein each of said nozzles is configured to inhibit the roof of the building from combusting, each of said nozzles having a coupled end and a free end, said coupled end of each of said nozzles being fluidly coupled to said upper end of each of said stand pipes, said free end of each of said nozzles being open thereby facilitating said free end of each of said nozzles to spray the extinguishing fluid outwardly from said free end, each of said stand pipes being oriented such that said upper end of each of said stand pipes is directed toward a common point located above the roof of the building thereby facilitating each of said nozzles to spray a stream of said extinguishing fluid in an arc which intersects at said common point above the roof thereby facilitating said stream of extinguishing fluid sprayed from each of said nozzles to form a cascading shower of said extinguishing fluid onto the roof;
a control unit being positioned proximate the building, said control unit being in communication with said pump, said control unit receiving an actuate input, said pump being turned on when said control unit receives said actuate input, said control unit comprising:
a control circuit being electrically coupled to said pump, said control circuit receiving said actuate input, said control circuit turning said pump on when said control circuit receives said actuate input, said control circuit being electrically coupled to a power source comprising an electrical system of the building;
a transceiver being electrically coupled to said control circuit, said transceiver being in wireless communication with an extrinsic communication network wherein said transceiver is configured to be in remote communication with a personal electronic device of an occupant of the building, said control circuit receiving said actuate input when said transceiver receives an actuate command from the extrinsic communication network wherein said transceiver is configured to facilitate the personal electronic device to actuate said pump; and
at least one heat sensor being positioned on the roof of the building wherein said heat sensor is configured to sense the temperature of the roof, said at least one heat sensor being electrically coupled to said control circuit, said control circuit receiving said actuate input when said at least one heat sensor senses a temperature exceeding a pre-determined trigger temperature.
